(19) United States
(12) Patent Application Publication
(10) Pub. No.: US 2026/0084975 A1
(43) Pub. Date: Mar. 26, 2026

(54) LITHIUM RECOVERY METHOD AND LITHIUM RECOVERY DEVICE

(71) Applicant: HONDA MOTOR CO., LTD., Tokyo (JP)

(72) Inventors: Mitsumasa Sorazawa, Wako-shi (JP); Yushi Fujinaga, Wako-shi (JP); Takayuki Sakata, Wako-shi (JP); Satoru Takahashi, Wako-shi (JP)

(21) Appl. No.: 19/335,300

(22) Filed: Sep. 22, 2025

(30) Foreign Application Priority Data
Sep. 26, 2024 (JP) 2024-167548

(51) Int. Cl. C01D 15/02; B01D 61/46; C22B 3/02; C22B 3/22; C22B 3/42; C22B 7/00; C22B 26/12; H01M 10/54

(52) U.S. Cl. CPC C01D 15/02; B01D 61/461; C22B 3/02; C22B 3/22; C22B 3/42; C22B 7/006; C22B 26/12; H01M 10/54; B01D 2311/04

(57) ABSTRACT

A lithium recovery method includes a process of agitating a treated member of an inactivated lithium ion secondary battery in pure water, dispersing a water-soluble solid electrolyte contained in the treated member into pure water, a filtrate, a separation liquid after extraction, or a mixed liquid of the pure water, the filtrate and the separation liquid after extraction to prepare a dispersion liquid, a process of separating solids contained in the dispersion liquid to recover a separation liquid, and a process of extracting a lithium hydroxide aqueous solution from the separation liquid by electrodialysis using a cation exchange membrane.

### CROSS-REFERENCE TO RELATED APPLICATION

Priority is claimed on Japanese Patent Application No. 2024-167548, filed Sep. 26, 2024, the content of which is incorporated herein by reference.

### BACKGROUND OF THE INVENTION

### Field of the Invention

The present invention relates to a lithium recovery method and a lithium recovery device.

### Description of Related Art

In recent years, efforts to significantly reduce generation of waste matter through prevention, reduction, recycling and reuse of the waste matter have become more active. To achieve this goal, research and development is being conducted into methods for recycling used lithium ion secondary batteries. One known method for recycling lithium ion secondary batteries, for example, is to dismantle used lithium ion secondary batteries and separate and recover battery materials.

A lithium recovery method using electrodialysis with a solid electrolyte membrane is known. As the lithium recovery method, for example, a method for producing lithium hydroxide is known, which includes first mixing of mixing an aqueous solution containing lithium and at least one or more elements other than lithium and a base in a reactor to adjust a pH to between 6 and 10, and second mixing of mixing them to adjust the pH to 12 or more, to obtain a lithium ion extract by removing hydroxides of elements other than lithium produced by the first mixing and the second mixing, to recover only lithium ions from the lithium ion extract into a recovered liquid using electrochemical equipment equipped with a Li selectively permeable membrane, and to adjust the pH by returning the lithium ion extract from which lithium ions have been recovered by the electrochemical equipment to the reactor (for example, see PCT International Publication No. 2022/203055).

As another lithium recovery method, for example, a method is known which uses a lithium selectively permeable membrane (solid electrolyte membrane) to recover lithium ions from a lithium ion extract containing lithium ions extracted from treated members of a lithium ion secondary battery, and which includes adjusting at least one of a temperature of the lithium ion extract and a temperature of the lithium selectively permeable membrane to 30° C. or more and 100° C. or less and moving the lithium ions to the recovered liquid that is an aqueous solution in order to recover lithium in the recovered liquid (for example, see Japanese Unexamined Patent Application, First Publication No. 2022-75618).

### SUMMARY OF THE INVENTION

However, in the methods disclosed in PCT International Publication No. 2022/203055 and Japanese Unexamined Patent Application, First Publication No. 2022-75618, a problem to be solved is that lithium cannot be recovered solely. In addition, in the methods disclosed in PCT International Publication No. 2022/203055 and Japanese Unexamined Patent Application, First Publication No. 2022-75618, since the efficiency of lithium recovery by electrodialysis using the solid electrolyte membrane is reduced unless the pH of the recovered raw liquid is kept between 12 and 14 due to the properties of the solid electrolyte membrane, lithium must be concentrated or other treatment is required. In order to maintain the pH of recovered raw liquid at 12 or more and 14 or less, it is necessary to add liquid preparations, but there is a problem that these liquid preparations can cause side effects.

In addition, in the methods disclosed in PCT International Publication No. 2022/203055 and Japanese Unexamined Patent Application, First Publication No. 2022-75618, since the ion permeability of the solid electrolyte membrane decreases near a room temperature, heat treatment of the recovered raw liquid is necessary, which poses problems in terms of the equipment and energy burden.

An aspect of the application is directed to providing a lithium recovery method and a lithium recovery device capable of recovering lithium solely and eliminating necessity of addition of a preparation liquid to adjust pH, and contributing to a significant reduction in generation of waste matter.

The present invention has the following aspects.
[1] A lithium recovery method including:
a process of agitating a treated member of an inactivated lithium ion secondary battery in pure water, dispersing a water-soluble solid electrolyte contained in the treated member into pure water, filtrate, separation liquid after extraction, or mixed liquid of the pure water, the filtrate and the separation liquid after extraction to prepare dispersion liquid;
a process of separating solids contained in the dispersion liquid to recover separation liquid; and
a process of extracting a lithium hydroxide aqueous solution from the separation liquid by electrodialysis using a cation exchange membrane.

According to the above-mentioned aspect, lithium can be recovered solely from the dispersion liquid containing positive electrode active material by electrodialysis using the cation exchange membrane without addition of a preparation liquid to adjust the pH or heating recovered raw liquid using a heating device.
[1] A lithium recovery device configured to extract a lithium hydroxide aqueous solution from dispersion liquid obtained by dispersing a water-soluble solid electrolyte, which is contained in a treated member of an inactivated lithium ion secondary battery, into pure water, filtrate, separation liquid after extraction, or mixed liquid of the pure water, the filtrate and the separation liquid after extraction by electrodialysis, the lithium recovery device including:
a treatment tank configured to treat the dispersion liquid by electrodialysis;
a cation exchange membrane installed in the treatment tank so as to divide the dispersion liquid and the lithium hydroxide aqueous solution by placing the dispersion liquid on a side of one main surface and the lithium hydroxide aqueous solution on a side of the other main surface;
a first electrode disposed on the side of the one main surface of the cation exchange membrane; and
a second electrode disposed on the side of the other main surface of the cation exchange membrane.

According to the above-mentioned aspect, lithium can be recovered solely from the dispersion liquid containing the positive electrode active material by electrodialysis using the cation exchange membrane alone, without addition of a preparation liquid to adjust the pH.

According to the aspect of the present invention, it is possible to provide a lithium recovery method and a lithium recovery device capable of recovering lithium solely and eliminating necessity of addition of a preparation liquid to adjust pH.

### BRIEF DESCRIPTION OF THE DRAWINGS

FIG. 1 is a flowchart of a lithium recovery method according to an embodiment of the present invention.

FIG. 2A is a cross-sectional view schematically showing a lithium recovery device according to an embodiment of the present invention.

FIG. 2B is a cross-sectional view schematically showing a lithium recovery device according to an embodiment of the present invention, and is a view of enlarging a part around a cation exchange membrane.

FIG. 3 is a view showing results after measuring voltages of a solution in Experimental Example 1.

FIG. 4 is a view showing results after estimating a sulfur permeability of a cation exchange membrane in Experimental Example 2.

FIG. 5 is a view showing results after estimating a lithium permeability of a cation exchange membrane in Experimental Example 3.

FIG. 6 is a view showing results after estimating a lithium recovery rate by electrodialysis using a cation exchange membrane in Experimental Example 4.

### DETAILED DESCRIPTION OF THE INVENTION

Hereinafter, although an embodiment of the present invention will be described in detail, the following description is one example of an embodiment of the present invention, and the present invention is not limited to these contents, and can be modified and implemented within the scope of the present invention.

### Lithium Recovery Method

A lithium recovery method according to an embodiment of the present invention is a method of recovering lithium from a used lithium ion secondary battery.

The lithium recovery method according to the embodiment of the present invention includes a process of agitating a treated member of an inactivated lithium ion secondary battery in pure water and dispersing a water-soluble solid electrolyte, which is contained in the treated member, in pure water, a filtrate, a separation liquid after extraction or a mixed liquid of the pure water, the filtrate and the separation liquid after extraction in order to prepare a dispersion liquid (hereinafter, referred to as “a solution preparing process”), a process of separating solids contained in the dispersion liquid and recovering a separation liquid (hereinafter, referred to as “a recovering process”), and a process of extracting a lithium hydroxide aqueous solution from the separation liquid by electrodialysis using a cation exchange membrane (hereinafter, referred to as “an extracting process”).

An example of a lithium ion secondary battery is an all-solid battery that uses a water-soluble electrolyte such as a sulfide or the like.

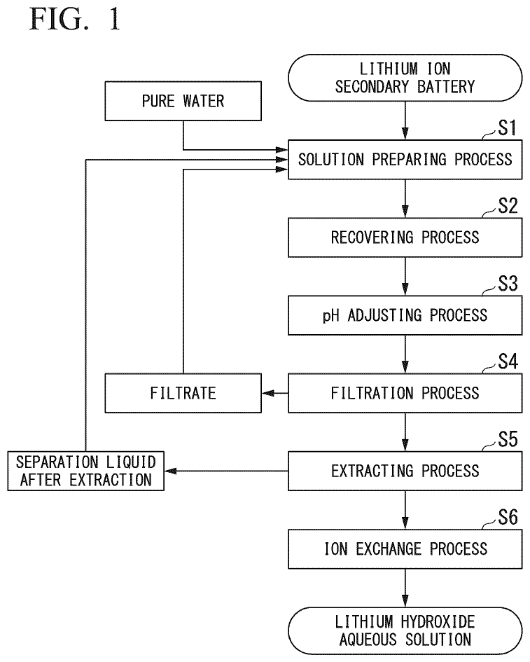

FIG. 1 is a flowchart of the lithium recovery method of the embodiment.

### (Solution Preparing Process)

In a solution preparing process S1, after the used lithium ion secondary battery is inactivated, a treated member of the inactivated lithium ion secondary battery is agitated in pure water, and a water-soluble solid electrolyte contained in the treated member is dispersed in pure water to prepare a dispersion liquid. Further, the treated member is a member that constitutes an inactivation-treated lithium ion secondary battery.

The inactivation treatment of the used lithium ion secondary battery can be performed by a known method (for example, see Japanese Unexamined Patent Application, First Publication No. 2023-124857, PCT International Publication No. 2021/201151, and the like).

The treated member contains a positive electrode active material, positive electrode materials (conductive additive, binder, and the like) other than the positive electrode active material, copper, electrolyte-derived sulfur or phosphorous in a negative electrode current collector, a current collecting tab, a current collector, and the like. For example, the current collector and a positive electrode containing the positive electrode active material layer formed on the current collector are crushed and dispersed into a desired size of pieces, filtrate, separation liquid after extraction, or mixed liquid thereof to prepare dispersion liquid. The obtained dispersion liquid contains the positive electrode active material, the positive electrode material other than the positive electrode active material, the current collecting tab, the current collector, and the like, as solids.

The positive electrode active material is not particularly limited, and may be a material known as a positive electrode active material for lithium ion secondary batteries. Examples of the positive electrode active material include a ternary positive electrode material such as LiCoO₂, LiNiO₂, NCM (Li(NiₓCo_{y}Mn_{z})O₂, (0<x<1, 0<y<1, 0<z<1, x+y+z=1)), or the like, layered positive electrode active material particles such as LiVO₂, LiCrO₂, or the like, a spinel type positive electrode active material such as LiMn₂O₄, Li(Ni_{0.25}Mn_{0.75})₂O₄, LiCoMnO₄, Li₂NiMn₃O₈, or the like, an olivine type positive electrode active material such as LiCoPO₄, LiMnPO₄, LiFePO₄, or the like, and the like.

In the solution preparing process S1, the reason for using pure water is that natural water or tap water contains minerals such as alkali metals as well as alkaline earth metals, such as sodium, potassium, calcium, and magnesium, which impair the separation properties of the cation exchange membrane. The alkali metals and alkaline earth metals are contaminants of recovering lithium. In addition, the filtration or the separation liquid after extraction does not contain these contaminants, making it possible to increase the lithium concentration in the dispersion liquid and reducing the amount of pure water used.

In the solution preparing process S1, the pH of the dispersion liquid is 11 or more and 14 or less because the dispersion liquid contains a solid electrolyte containing lithium. In order to achieve a lithium recovery rate of 80% or more, it is necessary that the lithium dissolution in the dispersion liquid is 0.4 mol/L or more, preferably 0.7 mol/L or more.

### (Recovering Process)

In a recovering process S2, the solids such as the positive electrode active material, the positive electrode material other than the positive electrode active material, the current collecting tab, the current collector, and the like, contained in the dispersion liquid are filtered out, separated and removed to recover the separation liquid. Here, non-water soluble solids in the lithium ion secondary battery are removed. Examples of the non-water soluble solids include a positive electrode active material, a binder, a conductive additive, a tab, an electrode, and the like.

The separation liquid obtained in the recovering process S2 includes, for example, chlorine (Cl), bromine (Br), phosphorous (P), sulfur(S), aluminum (Al), nickel (Ni), copper (Cu), and the like.

### (pH Adjusting Process)

The lithium recovery method of the embodiment may include a pH adjusting process S3. In the pH adjusting process S3, the pH of the separation liquid is adjusted. The pH of the separation liquid is preferably 7 or more and 10 or less. The pH value is adjusted by converting dissolved hydrogen sulfide into sulfuric acid by bubbling, or by a neutralization reaction by adding an acid liquid such as sulfuric acid or the like.

In the pH adjusting process S3, by adjusting the pH of the separation liquid to fall within the above range, metallic components such as aluminum (Al), nickel (Ni), copper (Cu), and the like, contained in the dispersion liquid are removed.

### (Filtration Process)

The lithium recovery method of the embodiment may include a filtration process S4. In the filtration process S4, from the separation liquid that has gone through the pH adjusting process S3, the solids (compounds containing aluminum, compound containing nickel, compound containing copper, etc.) are separated and removed by filtration.

### (Extracting Process)

In extracting process S5, a lithium hydroxide aqueous solution is extracted from the separation liquid by electrodialysis using a cation exchange membrane.

In the extracting process S5, examples of materials for cation exchange membranes include sodium sulfonate, polyolefin, and the like. As lithium becomes more concentrated in the lithium hydroxide aqueous solution, its pH becomes 12 or higher, while the separation liquid of the recovering source becomes strongly oxidized to around pH 1 as the lithium decreases and the oxidation of the anion components progresses, so the cation exchange membrane requires a wide pH resistance.

According to the electrodialysis using the cation exchange membrane, the lithium ions contained in the separation liquid pass through the cation exchange membrane, and on the passed side, the lithium ions react with water to become lithium hydroxide. That is, an aqueous solution of lithium hydroxide is produced on the side that has permeated the cation exchange membrane. An example of the electrodialysis method is a method in which constant current processing is 0.3 A and the inter-electrode voltage is stopped when it reaches a withstand voltage limit of the membrane as a trigger. In addition, as an example of the electrodialysis method, constant voltage processing can be used, in which the voltage is set below a pressure resistance of the membrane and the process stops when the current value falls below a constant value.

In the extracting process S5, copper (Cu), nickel (Ni), aluminum (Al), phosphate ion (PO₄³⁻), and the like, do not pass through the cation exchange membrane. Chlorine (Cl), bromine (Br), sulfate ion (SO₄²⁻), and the like, hardly penetrate the cation exchange membrane. For this reason, in the extracting process S5, these materials and lithium are separated.

### (Ion Exchange Process)

The lithium recovery method of the embodiment may include an ion exchange process S6. In the ion exchange process S6, the lithium hydroxide aqueous solution obtained in the extracting process S5 is brought into contact with an anion exchange resin to remove a small amount (ppm order) of chlorine (Cl), bromine (Br), sulfate ion (SO₄²⁻), and the like, contained in the lithium hydroxide aqueous solution.

In the ion exchange process S6, a temperature at which the lithium hydroxide aqueous solution is brought into contact with the anion exchange resin is preferably 10° C. or more and 40° C. or less.

Through the above process, a high-purity aqueous solution of lithium hydroxide can be obtained.

According to the lithium recovery method of the embodiment, lithium can be solely recovered from the aqueous solution containing the positive electrode active material by electrodialysis using the cation exchange membrane, without addition of the preparation liquid to adjust the pH.

### Lithium Recovery Device

A lithium recovery device according to an embodiment of the present invention is a device configured to recover lithium from a used lithium ion secondary battery.

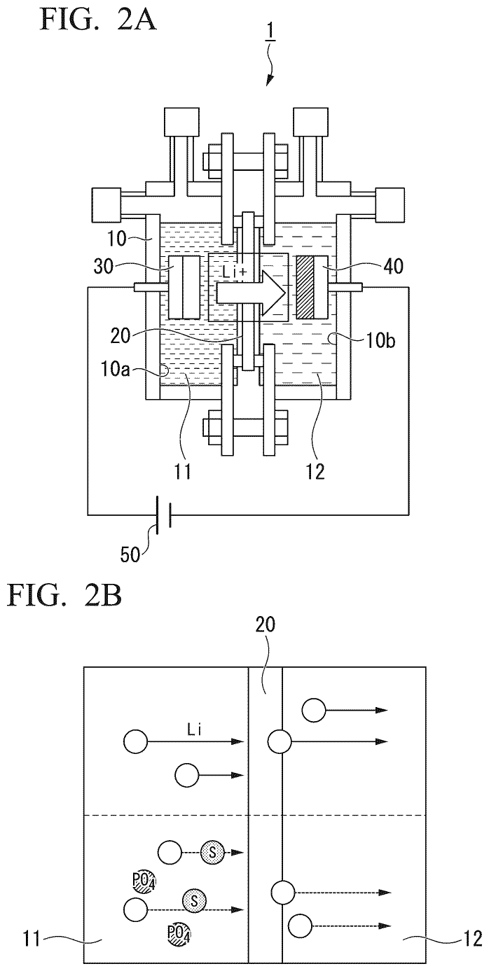

FIG. 2A is a cross-sectional view schematically showing the lithium recovery device of the embodiment. FIG. 2B is a cross-sectional view schematically showing a lithium recovery device according to an embodiment of the present invention, and is a view of enlarging a part around a cation exchange membrane 20.

A lithium recovery device 1 includes a treatment tank 10, a cation exchange membrane 20, a first electrode 30, a second electrode 40, and a power supply 50.

The treatment tank 10 has a first space 11 and a second space 12 partitioned by the cation exchange membrane 20 installed in the treatment tank 10. An inner side surface of the first space 11 facing and spaced apart from the cation exchange membrane 20 is defined as one main surface 10a of the treatment tank 10. An inner side surface of the second space 12 spaced apart from and facing the cation exchange membrane 20 is defined as the other main surface 10b of the treatment tank 10.

The treatment tank 10 is a tank in which the water-soluble solid electrolyte contained in the treated member of the inactivated lithium ion secondary battery is dispersed in pure water, and the resulting dispersion liquid is treated by electrodialysis.

The cation exchange membrane 20 is disposed in the center portion of the treatment tank 10 in the height direction of the treatment tank 10 so as to partition the first space 11 and the second space 12 of the treatment tank 10.

The cation exchange membrane 20 can be the same as that used in the lithium recovery method of the embodiment described above.

The first electrode 30 is disposed in the first space 11 on the side of the one main surface 10a of the treatment tank 10.

The second electrode 40 is disposed in the second space 12 on the side of the other main surface 10b of the treatment tank 10.

The power supply 50 is connected to the first electrode 30 and the second electrode 40. The power supply 50 applies the voltage required for electrodialysis to the first electrode 30 and the second electrode 40.

The lithium recovery method by the lithium recovery device 1 of the embodiment will be described.

A separation liquid is prepared by undergoing the solution preparing process S1, the recovering process S2, the pH adjusting process S3, and the filtration process S4 in the lithium recovery method of the above-mentioned embodiment.

In the lithium recovery device 1 of the embodiment, the extracting process S5 in the lithium recovery method of the above-mentioned embodiment is performed.

The separation liquid is injected into the first space 11 of the treatment tank 10, and a dilute lithium hydroxide solution is injected as recovered liquid into the second space 12 of the treatment tank 10 to ensure conductivity.

In this state, when a voltage is applied from the power supply 50 to the first electrode 30 and the second electrode 40, electrodialysis begins, and the lithium ions contained in the separation liquid in the first space 11 permeate the cation exchange membrane and move to the recovered liquid in the second space 12. The lithium ions that pass through the cation exchange membrane react with the water in the second space 12 to become lithium hydroxide. That is, the lithium hydroxide aqueous solution is generated in the second space 12. Further, since the small amount (ppm order) of chlorine (Cl), bromine (Br), and sulfate ion (SO₄²⁻) pass through the cation exchange membrane, the lithium hydroxide aqueous solution contains the small amount (ppm order) of chlorine (Cl), bromine (Br), and sulfate ion (SO₄²⁻).

According to the lithium recovery device of the embodiment, lithium can be recovered solely from the aqueous solutions containing the positive electrode active material by electrodialysis using the cation exchange membrane, without addition of the preparation liquid to adjust the pH.

Hereinabove, while the embodiment of the present invention has been described in detail, the present invention is not limited to the above-mentioned embodiment, and various modifications and changes are possible within the scope of the present invention described in the claims.

### EXAMPLES

The present invention will be described in more detail below using experimental examples, however, the present invention is not limited to the following experimental examples.

### Experimental Example 1

A voltage between cathode and anode terminals was measured by passing a current through a solution in the treatment tank of the lithium recovery device while using each of a solid electrolyte membrane consisting of Li₂O—Al₂O₃—SiO₂—P₂O₅—TiO₂-based materials, a cation exchange membrane consisting of sodium sulfonate, a cation exchange membrane consisting of polyolefin (A), a cation exchange membrane consisting of polyolefin (B), a cation exchange membrane consisting of polyolefin (C), a cation exchange membrane consisting of fluorine-based sulfonic acid, and a cation exchange membrane consisting of hydrocarbon are dissolved, as the cation exchange membrane of the lithium recovery device.

The atmospheric temperatures of the lithium recovery device are set to 20° C., 40° C., 60° C., 80° C., and 90° C. and the voltage at each temperature was measured.

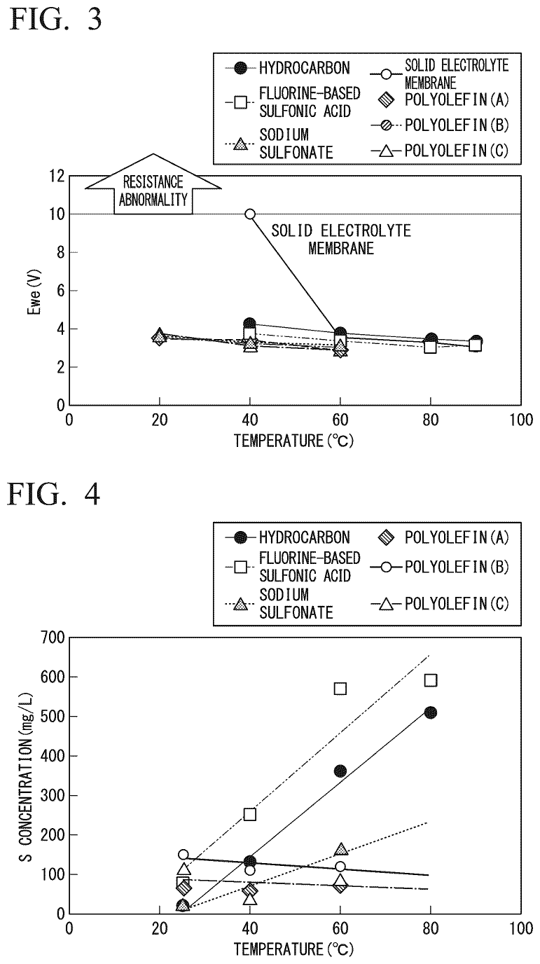

Measurement results are shown in FIG. 3.

From the results shown in FIG. 3, it was found that the solid electrolyte membrane had low ion permeability at room temperature and required heat treatment.

### Experimental Example 2

A sulfur permeability(S) in a cation exchange membrane consisting of sodium sulfonate, a cation exchange membrane consisting of polyolefin (A), a cation exchange membrane consisting of polyolefin (B), a cation exchange membrane consisting of polyolefin (C), a cation exchange membrane consisting of fluorine-based sulfonic acid, and a cation exchange membrane consisting of hydrocarbon was examined.

To estimate the transparency of each membrane, components of lithium aqueous solution after electrodialysis were analyzed. Cr, Br, PO₄, SO₄, and the like, were analyzed by ion chromatography (IC), and a total S amount and a total P amount were analyzed by inductively coupled plasma spectroscopy (ICP).

Temperatures upon estimation were 20° C., 40° C., 60° C., and 80° C.

Measurement results are shown in FIG. 4.

From the results shown in FIG. 4, it was found that the sulfur permeability in the cation exchange membrane consisting of fluorine-based sulfonic acid and the cation exchange membrane consisting of hydrocarbons increases with increasing a temperature, so that it is desirable to use the membrane at temperatures below 40° C.

### Experimental Example 3

A lithium permeability (Li) in a cation exchange membrane consisting of sodium sulfonate, a cation exchange membrane consisting of polyolefin (A), a cation exchange membrane consisting of polyolefin (B), and a cation exchange membrane consisting of polyolefin (C), was examined.

To estimate the transparency of each membrane, components of lithium aqueous solution after electrodialysis were analyzed. Cr, Br, PO₄, SO₄, and the like, were analyzed by ion chromatography (IC), and a total S amount and a total P amount were analyzed by inductively coupled plasma spectroscopy (ICP).

Temperatures upon estimation were 25° C., 40° C., and 60° C.

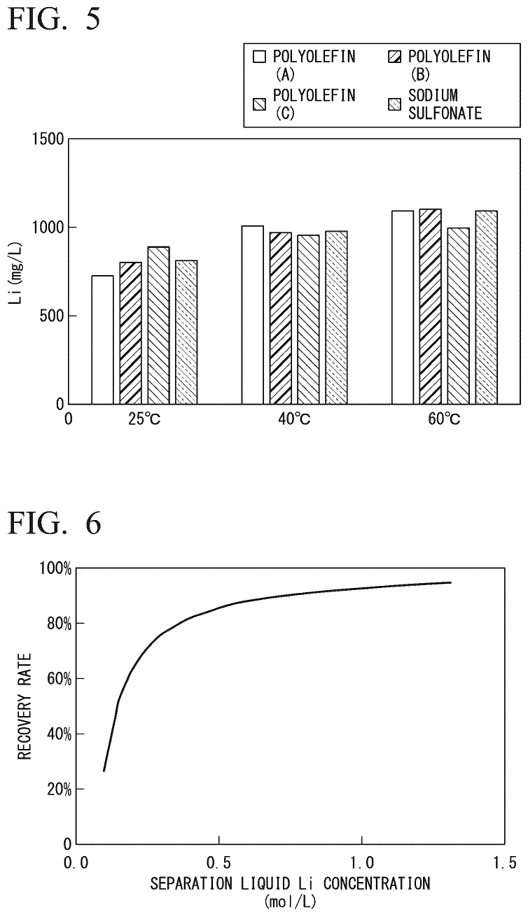

Measurement results are shown in FIG. 5.

From the results shown in FIG. 5, it was found that the lithium permeability was increased in the following order of polyolefin (A)<polyolefin (B)<polyolefin (C)≈sodium sulfonate.

### Experimental Example 4

In electrodialysis using a cation exchange membrane consisting of sodium sulfonate, the effect of changing the amount of lithium contained in the separation liquid on the lithium recovery rate was examined.

In a method of estimating the lithium recovery rate, the amount of lithium before and after electrodialysis of the separation liquid was analyzed by inductively coupled plasma spectroscopy (ICP).

Measurement results are shown in FIG. 6.

From the results shown in FIG. 6, it was found that the higher the lithium concentration in the separation liquid, the higher the lithium recovery rate, and that a lithium concentration of 0.4 mol/L or more, and preferably 0.7 mol/L or more, in the separation liquid is required to achieve a lithium recovery rate of 80% or more.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A lithium recovery method comprising:
a process of agitating a treated member of an inactivated lithium ion secondary battery in pure water, dispersing a water-soluble solid electrolyte contained in the treated member into pure water, a filtrate, a separation liquid after extraction, or a mixed liquid of the pure water, the filtrate and the separation liquid after extraction to prepare a dispersion liquid;
a process of separating solids contained in the dispersion liquid to recover a separation liquid; and
a process of extracting a lithium hydroxide aqueous solution from the separation liquid by electrodialysis using a cation exchange membrane.

2. A lithium recovery device configured to extract a lithium hydroxide aqueous solution from a dispersion liquid obtained by dispersing a water-soluble solid electrolyte, which is contained in a treated member of an inactivated lithium ion secondary battery, into pure water, a filtrate, a separation liquid after extraction, or a mixed liquid of the pure water, the filtrate and the separation liquid after extraction by electrodialysis, the lithium recovery device comprising:
a treatment tank configured to treat the dispersion liquid by electrodialysis;
a cation exchange membrane installed in the treatment tank so as to divide the dispersion liquid and the lithium hydroxide aqueous solution by placing the dispersion liquid on a side of one main surface and the lithium hydroxide aqueous solution on a side of the other main surface;
a first electrode disposed on the side of the one main surface of the cation exchange membrane; and
a second electrode disposed on the side of the other main surface of the cation exchange membrane.
